(19) United States
(12) Patent Application Publication
(10) Pub. No.: US 2002/0134724 A1
(43) Pub. Date: Sep. 26, 2002

(54) Apparatus for filtering and separating fluids

(76) Inventors: Wilhelm Heine, Hamburg (DE); Ralph Gunther, Buchholz (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 09/866,216

(22) Filed: May 29, 2001

(30) Foreign Application Priority Data
Mar. 21, 2001 (EP) 01 106 990.3

(51) Int. Cl. B01D 63/00

(52) U.S. Cl. 210/323.1; 210/321.6

(57) ABSTRACT

In an apparatus for filtering and separating fluids, including a pressure-tight housing having a fluid inlet, a retentate outlet and a permeate outlet, a plurality of stacks of membrane filter elements are arranged in the housing adjacent one another and joined such that the fluid is conducted through the stacks of membrane filter element in a series flow pattern and each stack includes a plurality of spaced membrane pillows arranged in spaced relationship such that the fluid is conducted in a meander-like pattern through the stack.

### BACKGROUND OF THE INVENTION

The invention relates to an apparatus for filtering and separating fluids, preferably of salt-containing liquids, particularly on the basis of the principle of ultrafiltration. The apparatus comprises a pressure housing with an inlet for the fluid and outlets for the retentate and the permeate. The housing includes a plurality of spaced filter elements in the form of membrane pillows, around which the fluid is conducted. The filter elements are arranged in the housing in separate stacks of membrane pillows, which are arranged in series in the fluid flow path.

Such an apparatus is known for example from EP-A-0 707 884. In the apparatus described in this publication, the stacks of spaced membrane pillows define together an unrestricted flow path for the fluid through the apparatus, whereby the fluid can pass through the apparatus from the inlet for the fluid to the outlet for the retentate at a relatively high speed. With this apparatus, volume flows of about 20 m³h⁻¹ are achieved. For the operation of this apparatus therefore generally at least two pumps are required, that is, one pump for generating a high operating pressure at which the apparatus needs to be operated and a second pump for pumping the fluid at high flow speeds through the apparatus. The operation of the at least two pumps for the operation of the apparatus requires the availability of a substantial amount of electric energy. This may be disadvantageous for certain applications particularly if the electric energy is not available where the apparatus is to be used. Also, the centrifugal pumps used in this connection for generating the high operating pressure in cooperation with the pump employed for pumping the fluid at high flow speed through the apparatus are problematic.

It is the object of the present invention to provide an apparatus for filtering and separating fluids wherein for generating the operating pressure in the pressure housing and for pumping the fluid to be filtered or separated through the housing only one pump is needed. The apparatus should also be easy to clean and service when this should become necessary. Also, the apparatus should be relatively simple and inexpensive to manufacture while presently known design principles are maintained. Furthermore, it should be possible to adapt the apparatus to the individual load factors of the fluid to be separated.

### SUMMARY OF THE INVENTION

In an apparatus for filtering and separating fluids, including a pressure-tight housing having a fluid inlet, a retentate outlet and a permeate outlet, a plurality of stacks of membrane filter elements are arranged in the housing adjacent one another and joined such that the fluid is conducted through the stacks of membrane filter element in a series flow pattern and each stack includes a plurality of spaced membrane pillows arranged in spaced relationship such that the fluid is conducted in a meander-like pattern through the stack.

With the arrangement according to the invention, one of the two centrifugal pumps needed heretofore, that is, the pump employed for providing the flow speed can be omitted. Only one pump is needed for the operation of the apparatus since, because of much lower volume flow of for example 0.8 m³h⁻¹, the operating pressure and the flow of the fluid to be separated can be generated by only one pump. Nevertheless, the arrangement according to the invention, which may be operated at a pressure of up to 120 bar and above, permits the adaptation of the apparatus to the individual load factor of the fluid to be separated as it is possible with the prior art apparatus which however requires a relatively high energy input. The fluids may be solutions from waste water treatment processes, which are rich in salts as they are present for example in animal husbandry, that is, for example, pig and cattle urine but the fluid may also be sea water. For the adaptation to a particular fluid, the number of stacks and the number of membrane pillows in a stack can be selected as necessary.

Since the apparatus can be operated at a very high operating pressure of up to 120 bar or, under certain conditions, above this value, a certain pressure drop between the inlet and the outlet of the apparatus as a result of the meander-like flow path of the fluid through the stack can be accommodated.

In order to ensure that, with the present design, the fluid flows through subsequent stacks in a meander-like fashion, the stacks form each a volume which is in communication with an inlet and an outlet for the fluid but which is otherwise closed. In this way, it is also ensured that the same volume flow passes through all the stacks of an apparatus.

In order to establish such a closed stack volume with a simple design the space is delimited preferably by a separating element which may be square or oblong and the separating element includes an inlet and an outlet preferably in the form of slots which have preferably a shape corresponding to the cross-sectional area of the flow passage for the fluid between two membrane pillows arranged in the stack in spaced relationship.

The membrane pillows may have a shape as desired; they are however, preferably oblong corresponding to the shape of the modular apparatus or rather the shape of an enclosure element forming the space, in which a stack of membrane pillows is contained within the pressure housing.

The membrane pillows are manufactured in a way well known in the art. They have at least one permeate discharge opening through which the permeate collected in the space between the outer membrane elements, which form the membrane pillow, is discharged.

It is very advantageous to arrange the membrane pillows in the stack in a displaced fashion such that one end of each alternate membrane pillow is disposed adjacent the separating element. In this way, no particular means are needed for redirecting the fluid, after passing over one side of a membrane pillow, to flow over the opposite side in the opposite direction. With such a staggered arrangement of the membrane pillows, the membrane pillows themselves form the redirecting means for the fluid.

Although, it is possible to make the membrane pillows, which basically have a relatively unstable shape, stable by suitable support structures, such stabilizing means are relatively expensive and they are also annoying during disassembly in case of damage to the membrane pillows or during servicing. Also, the provision of spacer elements as they are known from the state of the art and on which the membrane elements can be held in a stable state, has the disadvantage that the pressure drop of the fluid from the inlet of the apparatus to the outlet thereof is increased. There is also the likelihood that deposits are formed at the support points of the membrane pillows on the spacer elements, which must be avoided under any circumstances. For these reasons, the membrane pillows are preferably stabilized by a plate-like stabilizing element, which is arranged between the outer membrane elements of adjacent membrane pillows. The stabilizing element is so designed that the membrane element is held in a tightly stretched manner also at high operating pressures and high flow speeds of the fluid over the membrane elements. As a result, the membrane pillows of a membrane stack also remain in spaced relationship from one another. This is advantageous as deposits may be formed in areas where the pillows are in contact with one another resulting in a deterioration of the separating efficiency.

The stabilizing element consists preferably of plastic, but other suitable materials may be used such as compound materials or even metal. The selection of the material for the stabilizing element depends essentially on the type of fluid, and the fluid pressure, which is maintained in the apparatus.

It is also advantageous if annular spacer elements are used for the outer spacing of the membrane pillows. The annular spacer elements may include elastomer sealing elements. But also strip-like spacer elements could be provided for the outer membrane elements. This would facilitate the mounting of the stack of membrane pillows. The sealing elements can be formed by a separate top ring. But, with the use of a suitable material, an annular spacer of an elastic material may provide a seal without the need for a sealing element, in addition to maintaining a certain space between the membrane pillows.

As indicated already, the membrane pillow includes at least one permeate discharge opening, but it may be advantageous to provide a plurality of permeate discharge openings in the membrane pillow. Preferably, two discharge openings are arranged on an imaginary longitudinal axis of the oblong membrane pillow at different distances from the adjacent ends of the membrane pillows. In this way the membrane pillows arranged in a stack can be displaced with respect to one another, such that each alternate membrane pillow abuts the separating element with one end. With the permeate discharge openings arranged asymmetrically with respect to the distance from a narrow side or, respectively, the end of the membrane pillow, a meander-like flow channel is formed for the fluid by the stack without any other measures.

Preferably, the stacks have oblong cross-sections. This is true in a transverse cross-section as well as in a longitudinal cross-section correspondingly, also the membrane pillows are essentially oblong.

Such an arrangement of the stacks has the advantage that they can be easily accommodated in the apparatus. This is particularly true if the stacks are received in two semi-circular shell elements, which enclose two stacks of membrane pillows. The inner cross-section of the two interconnected shell elements is preferably oblong when the two shell elements are assembled. The dimensions are preferably so selected that the stack of membrane elements is tightly engaged between the two semi-circular shell elements. The membrane pillow can then, in cooperation with the spacer elements disposed therebetween, ensure that no additional mounting bolts or similar elements are necessary to keep the permeate discharge openings of the membrane pillow sealing while maintaining a predetermined distance between the membrane pillows for the flow of fluid therebetween.

Finally, the shell elements includes a permeate discharge channel, which extends longitudinally through the shell element and which is in communication with permeate discharge openings leading to the inner bottom area of the shell elements. With this arrangement, the permeate discharge channel is formed integrally with the shell elements which has the additional advantage that the need for separate discharge structures is eliminated, which reduces overall expenses for the apparatus.

An embodiment of the invention will be described in greater detail below on the basis of the accompanying drawings.

### BRIEF DESCRIPTION OF THE DRAWINGS

FIG. 1 is a longitudinal cross-sectional view of a fluid filtering and separating apparatus with two stack shells, each including a stack of membrane pillows forming meander-like flow paths for the fluid,

FIG. 2 shows an enlarged cross-sectional area of FIG. 1 representing a complete stack disposed in the surrounding housing,

FIG. 3a and FIG. 3b show the flow scheme through two adjacent stacks of membrane pillows,

FIG. 4a is a plane view of a separating element for disposition between two stacks of membrane pillows,

FIG. 4b is a side view of the separating element shown in FIG. 4a,

FIG. 5 shows schematically a membrane pillow as used in the apparatus according to the invention with two permeate discharge openings arranged at the narrow side of the membrane pillow,

FIG. 6a is a side view of a disc-shaped spacer element, and

FIG. 6b is a front view of the disc-shaped spacer element shown in FIG. 6a.

### DESCRIPTION OF A PREFERRED EMBODIMENT

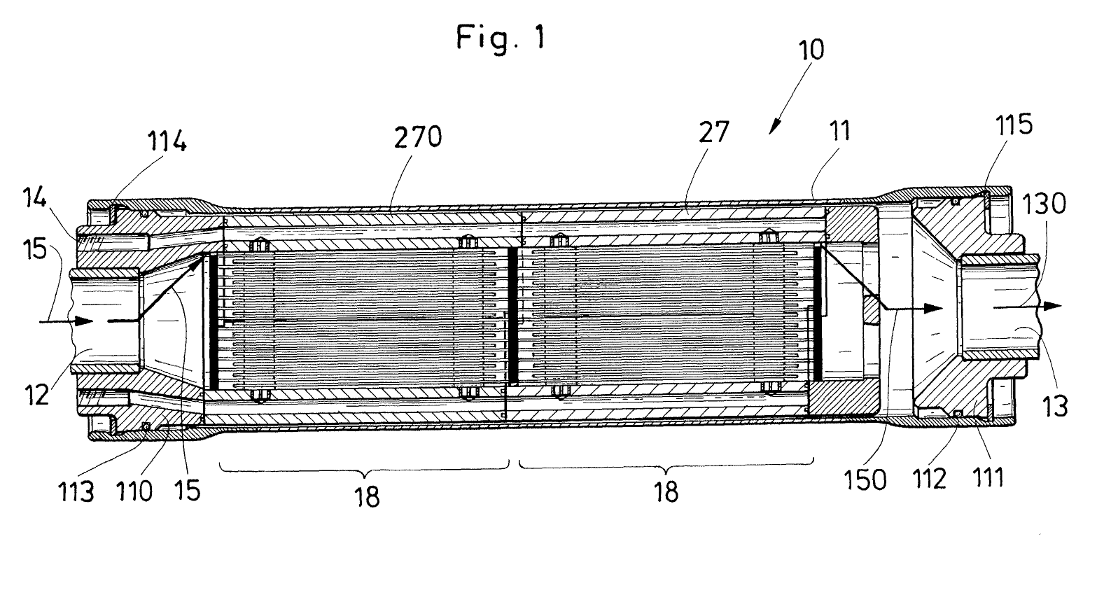

As shown in FIG. 1, the apparatus 10 for filtering and separating fluids consists essentially of a housing 11 which is closed and sealed at opposite ends by closure elements 110, 111 in a pressure tight manner. As circumferential sealing means 112, 113, for example O-rings may be used. The closure element 110 includes an inlet 12 for the fluid 15 to be supplied to the apparatus 10. The opposite closure element 111 includes an outlet 150 for the enriched fluid 150, which is called the retentate, and an outlet 14 for the permeate. The closure elements 110, 111 are secured in their positions in the housing 11 by locking rings 114, 115. The housing 11 is preferably circular in cross-section. However, another cross-sectional shape may be provided for the housing 11.

The housing 11 includes a plurality of stack shells 27, 270. Only two such stack shells being shown in the example of FIG. 1. It is pointed out however that any appropriate number of stack shells 27, 270 may be used in an apparatus 10 depending on the length of the housing 11 and also on the type of fluid to be separated as well as the amount of materials, which are contained in the fluid and are to be separated therefrom. Apparatus with ten such stack shells arranged one after the other have already been realized.

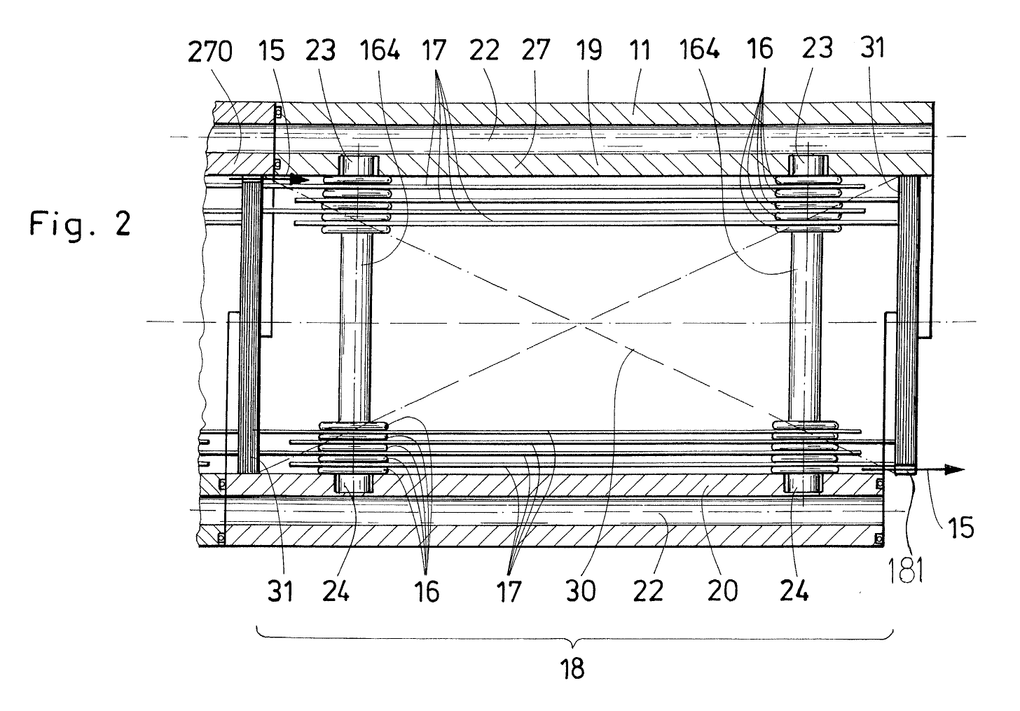

The stack of shells 27, 270 are all identical so that only one stack shell will be described below. As shown in FIG. 2, the stack shells 27 consists of two shell elements 19, 20. The shell elements 19, 20 have a semi-circular circumference. In the interior, they are essentially rectangular such that two elements which are joined form an inner space of essentially square cross-section. The shell elements 19, 20 may be interconnected by fastening means which are not shown in the drawing. It may be for example a removable bolt and nut joint. Two shell elements engage between them, in a tight manner, a stack 18, which is formed by a plurality of spacer element 16 and by membrane pillows 17—see FIGS. 2, 6a, and 6b. The membrane pillows 17 are arranged between the spacer elements 16. Such membrane pillows as they are used in the apparatus 10 for forming the stacks 18 together with the spacer elements 16 are disclosed for example in EP-8-0 129 663.

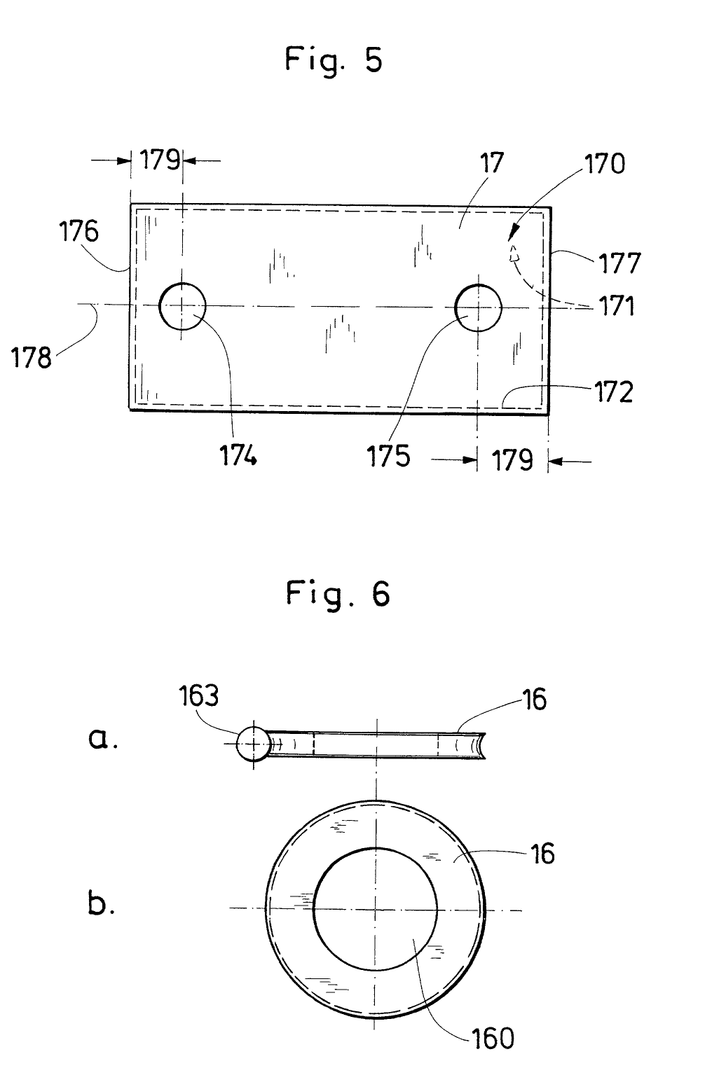

Since the membrane pillows 17 used in the apparatus 10 are known as to their construction from the aforementioned document, they are not described herein in detail. The known membrane pillows 17, however are somewhat modified for use in the apparatus 10 according to the invention in as much as a planar stabilizing elements 172 are disposed between the outer membrane elements 170, 171 which delimit the membrane pillow 17. A stabilizing element 172 is shown in FIG. 5 by dashed lines. The stabilizing element 172, which consists of plastic material, metal or another suitable material, is chamfered at its circumference from both sides to provide inclined leading edges so as to reduce the flow resistance for the fluid. The design of the membrane pillow 17 as modified herein with the respect to that used in the document referred to earlier provides for a high stability eliminating the need for the apparatus to include special spacer elements supporting the membrane pillows 17.

The spacer elements 16 are annular in the embodiments of the apparatus 10 as shown in the figures. Preferably, they consist of an elastomer material such as rubber or of a corresponding suitable plastic material. The spacer element 16 includes an opening 160 corresponding in size to the permeate discharge openings 174, 175 of the membrane pillow 17. For clarification, FIG. 6 is shown at an enlarged scale with respect to FIG. 5. The spacer element 16 provides a seal between two membrane pillows 17 as a result of the shape of the spacer element 16 itself or, additionally or alternatively, by a sealing element 163 shown in FIG. 6b by a dashed-dotted line representing for example an O-ring extending around the spacer element 16. The spacer element therefore forms a seal between two membrane pillows 17 between which it is engaged and determines also the distance between the two adjacent membrane pillows 17, which distance is established by its thickness. When the membrane pillows 17 are tightly stacked in a stack 18 with the spacer elements 16 disposed tightly between adjacent membrane pillows as shown in FIG. 2, no fluid 15 can escape to the permeate discharge openings 174, 175, because the spacer elements 16 form tight seals if necessary in cooperation with sealing elements as described earlier.

The permeate discharge openings 23, 24 in the shell elements 19, 20, which, in longitudinal direction, have the same distance from each other as the permeate discharge openings 174, 175 of the membrane pillow 17, lead to permeate discharge channels 22 extending longitudinally through the shell elements 19, 20. Each stack 18 includes tow discharge bolts 164, which extend through the whole stack 18 of membrane pillows 17 and spacer elements 16. The discharge bolts 164 include a plurality of axially extending permeate discharge grooves, which are not shown in the drawings, by way of which the permeate which leaves the membrane pillow 17 by way of the permeate discharge openings 174, 175, is conducted away and flows through the permeate discharge openings 23, 24 into the permeate discharge channels 22 of the shell elements 19, 20.

The stack 18 described above is enclosed between two shell elements 19, 20 in a tight manner by fastening means which have been mentioned earlier. When the shell elements 19, 20 are joined it is made sure that the permeate separated by the permeate 136 pillows 17 leaves the permeate pillows through the permeate discharge openings of the membrane pillows 17 by way of the openings 160 of the spacer elements 16, the permeate discharge grooves of the drain bolts 164 and the permeate discharge openings 23, 24 of the shell elements 19, 20. The permeate is collected in the permeate discharge channels 22 of the shell elements 19, 20 and conducted from there to the permeate outlet 14 of the apparatus. All adjacent stack shells 27, 270—in the example only two stack shells are shown—are removably interconnected by suitable connecting means incorporated into the stack shells 27, 270. These connecting means may be for example bayonet locks. Sealing elements arranged between the adjacent stack shells provide for a pressure tight fluid flow path with respect to the flow path of the permeate generated in the apparatus 10.

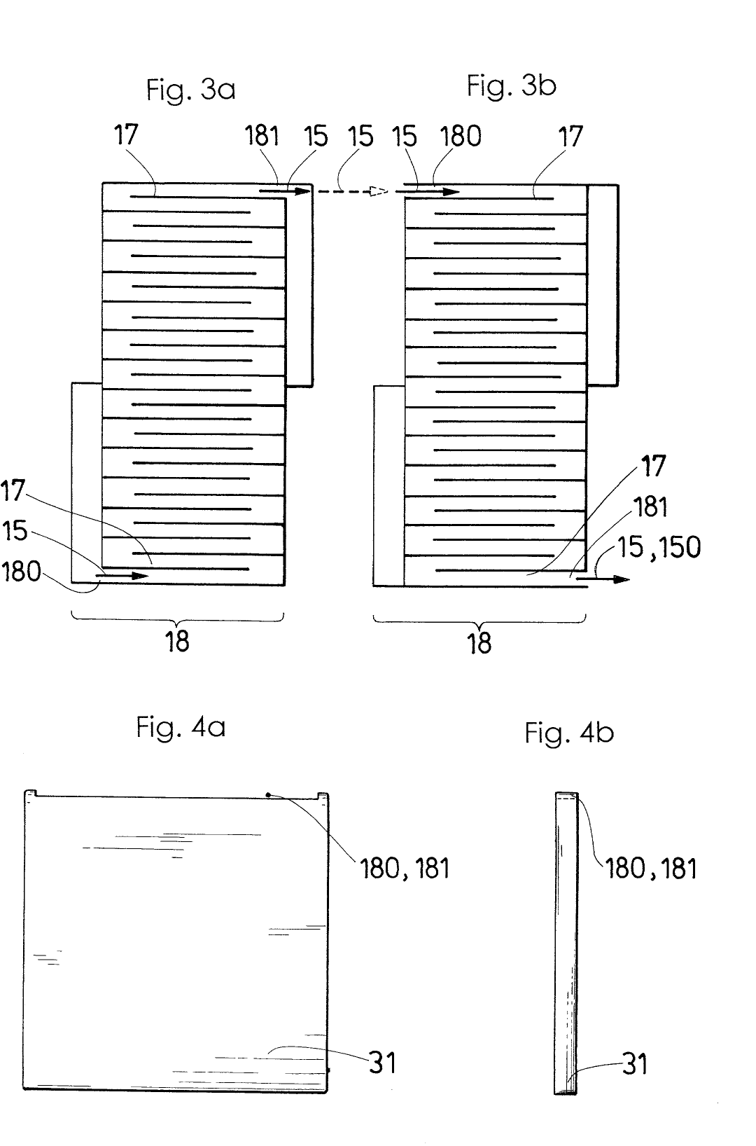

As shown in FIG. 2, the stacks 18 form together with the stack shells 27, 270 and the separating elements 31 (see FIGS. 4a, 4b) which extend at opposite ends across the stack shells, a closed space 30 indicated in FIG. 2 by the diagonally crossing dash-dotted lines. The separating elements 31 by which the space 30 is delimited in the longitudinal direction have an inlet 180 and an outlet 181 for the fluid 5 (FIGS. 3a, 3b). The inlets 120 and outlets 181 have slot-like shapes as shown in FIGS. 4a, 4b and also in FIG. 2a. In an apparatus 10, the inlets 180 and outlets 181 are arranged in subsequent stacks 18 alternately at opposite sides.

The membrane pillows 17 are arranged in each stack 18 in such a way that the fluid 15 flows around the membrane pillows in a meander-like pattern, see the flow pattern of two serially arranged stacks as shown in FIGS. 3a, 3b. The membrane pillows 17 are so designed (see FIG. 5) that the two permeate discharge openings 174, 175 are arranged at different distances 179, 179′ from the ends 176, 177 of the membrane pillows 17. The larger distance 179′ of the permeate opening 175 from one end of the membrane pillow as shown in FIG. 5 on the right ensures that the membrane pillow 17 abuts the separating element 31. The smaller distance 179 of the permeate discharge opening 174 from the other end of the membrane pillow 17, which is shown in FIG. 5 at the left provides for a space between the end 176 of the membrane pillow 17 and the separating element 31 thereby forming a fluid flow reversal path around the end 176 of the membrane pillow 17. With an alternate stacking of the membrane pillows 17 wherein each second membrane pillow 17 is turned by 180°, each second membrane pillow abuts with one end 177 the separating element 31. The same applies to the other end 176 where each first membrane pillow 17 engages the respective separating element 31 (FIG. 2). The fluid entering a stack 18 of membrane pillows 17 through the slot-like inlet 180 of the separating element 31 (see FIGS. 3a, b) is conducted by the membrane pillows 17 through the stack 18 of membrane pillows 17 along a predetermined meander-like path from the inlet 180 to the outlet 181. The outlet 181 is formed by the opposite separating element 31, which also forms the inlet 180 for the next downstream stack 18.

Depending on the purpose of the apparatus 10 a certain amount of stack shells is provided in the manner as described earlier. The pre-manufactured stack shells 27 are then assembled with the stacks 18 of spacer elements 16, draining bolts 164 and filter elements 17 stacked in the manner described above and are securely joined by suitable connecting means. Then the plurality of stack shells 27 which are interconnected are inserted into an opening of the housing 11. It is made sure that the permeate discharge channels 22 of the stack shells 27 are joined in a pressure-tight manner and are continuous from the last stack shell 27 to a corresponding opening of the closure element 111 of the housing 11. Then the housing 11 is closed by the opposite closure element 110. The closure elements are coked in position by the locking rings 115 and 114 respectively, whereby it is made sure that any axial movement of the plurality of interconnected stack shells 27 in the housing 11 is prevented.

Subsequently, for the operation of the apparatus 10, the fluid 15 is introduced into the apparatus 10 by way of the inlet 12 and reaches the space 30 by way of the inlet 180 of the separating element 31 of the first stack 18. In the space 30, the fluid 15 flows around the membrane pillows 17 in a meander-like pattern to the outlet 181 of the first stack 18. The outlet 181 of the first stack 18 forms the inlet 180 of the separating element 31 of the second stack 8 so that the fluid 15 is conducted into the second stack 18. In the second stack, the fluid 15 again meanders past the plurality of membrane pillows 17. After passing through all the serially arranged stacks 18 the concentrated fluid 150, which is the retentate, leaves the apparatus 10 through the outlet 13 and is conducted away in a suitable manner.

The permeate which is provided by the membrane pillows 17 in a well-known manner flows, by way of the openings 160 of the filter elements 16 and the permeate discharge openings 23, 24 of the shell elements 19, 20, to the permeate discharge channel 22 and from there to the outlet 14 of the apparatus 10, from where it is taken for further use.

What is claimed is:

1. An apparatus for filtering and separating fluids, comprising: a pressure tight housing having a fluid inlet, a retentate outlet and a permeate outlet, a plurality of stacks of membrane filter elements arranged in said housing adjacent one another and being joined such that said fluid is conducted through said stacks of membrane filter elements in a series flow pattern, each stack including a plurality of spaced filter elements in the form of membrane pillows arranged in spaced relationship around which fluid flow is conducted in a meander-like pattern through each to stack.

2. An apparatus according to claim 1, wherein each of said stacks includes a closed space in which said membrane pillows are contained and each includes further an inlet for conducting said fluid into said closed space and outlets for conducting said fluid out of said closed space, said stacks being arranged adjacent one another such that the outlet of one stack is in communication with the inlet of the next adjacent stack.

3. An apparatus according to claim 2, wherein separating elements are disposed between adjacent stacks delimiting said spaces, and said inlets and outlets are formed in said separating elements.

4. An apparatus according to claim 2, wherein said inlets and said outlets are slots formed in said separating elements.

5. An apparatus according to claim 1, wherein said membrane pillows are essentially oblong in shape.

6. An apparatus according to claim 3, wherein said membrane pillows are arranged in said stack in a longitudinally displaced fashion such that each alternate membrane pillow has one end projecting from said stack and disposed in engagement with the adjacent separating element thereby forming flow reversal areas at each end of said stack between the projecting ends of two alternate membrane pillows.

7. An apparatus according to claim 1, wherein each membrane pillow includes a planar stabilizing element disposed between outer membrane elements.

8. An apparatus according to claim 7, wherein spacer elements provided with elastomer sealing elements are disposed between adjacent membrane pillows.

9. An apparatus according to claim 8, wherein said sealing elements are O-rings.

10. An apparatus according to claim 5, wherein said membrane pillow are oblong and each includes at least two permeate discharge openings.

11. An apparatus according to claim 10, wherein said discharge openings are arranged along the longitudinal center axis of each membrane pillow and at different distances from the opposite ends thereof.

12. An apparatus according to claim 1, wherein said stacks have an essentially oblong cross-section.

13. An apparatus according to claim 2, wherein said stacks are formed by two essentially semi-circular stack shells which are joined to form within a space of oblong cross-section and which enclose therein said stacks of membrane pillows, which also have an oblong shape.

14. An apparatus according to claim 13, wherein said housing is closed at opposite ends by closure elements and at least one of said stack shells includes a permeate discharge channel extending longitudinally through said at least one stack shell and being disposed in communication with permeate discharge openings formed in said closure elements.

15. An apparatus according to claim 14, wherein the space defined within said stack shells has an oblong cross-section.
